(19) United States
(12) Patent Application Publication
(10) Pub. No.: US 2005/0200136 A1
(43) Pub. Date: Sep. 15, 2005

(54) Low cost hardware manufactured from conductive loaded resin-based materials

(75) Inventor: Thomas Aisenbrey, Littleton, CO (US)

Correspondence Address: GEORGE O. SAILE, 28 DAVIS AVENUE, POUGHKEEPSIE, NY, 12603, US

(73) Assignee: Integral Technologies, Inc.

(21) Appl. No.: 11/121,377

(22) Filed: May 4, 2005

Related U.S. Application Data
(63) Continuation-in-part of application No. 10/877,092, filed on Jun. 25, 2004.
Application No. 10/877,092 is a continuation of application No. 10/309,429, filed on Dec. 4, 2002, now Pat. No. 6,870,516.
Application No. 10/309,429 is a continuation-in-part of application No. 10/075,778, filed on Feb. 14, 2002, now Pat. No. 6,741,221.
(60) Provisional application No. 60/569,513, filed on May 6, 2004.
(60) Provisional application No. 60/317,808, filed on Sep. 7, 2001.
(60) Provisional application No. 60/269,414, filed on Feb. 16, 2001.
(60) Provisional application No. 60/268,822, filed on Feb. 15, 2001.

(51) Int. Cl. E05C 19/00

(52) U.S. Cl. 292/1

(57) ABSTRACT

Hardware fastener devices are formed of a conductive loaded resin-based material. The conductive loaded resin-based material comprises micron conductive powder(s), conductive fiber(s), or a combination of conductive powder and conductive fibers in a base resin host. The percentage by weight of the conductive powder(s), conductive fiber(s), or a combination thereof is between about 20% and 50% of the weight of the conductive loaded resin-based material. The micron conductive powders are formed from non-metals, such as carbon, graphite, that may also be metallic plated, or the like, or from metals such as stainless steel, nickel, copper, silver, that may also be metallic plated, or the like, or from a combination of non-metal, plated, or in combination with, metal powders. The micron conductor fibers preferably are of nickel plated carbon fiber, stainless steel fiber, copper fiber, silver fiber, aluminum fiber, or the like.

### RELATED PATENT APPLICATIONS

This patent application is related to U.S. patent application INT04-008B, Ser. No. ______, and filed on ______, which is herein incorporated by reference in its entirety.

This patent application claims priority to the U.S. Provisional Patent Application Ser. No. 60/569,513 filed on May 6, 2004, which is herein incorporated by reference in its entirety.

This patent application is a Continuation-in-Part of INT01-002CIPC, filed as U.S. patent application Ser. No. 10/877,092, filed on Jun. 25, 2004, which is a Continuation of INT01-002CIP, filed as U.S. patent application Ser. No. 10/309,429, filed on Dec. 4, 2002, now issued as U.S. Pat. No. 6,870,516, also incorporated by reference in its entirety, which is a Continuation-in-Part application of docket number INT01-002, filed as U.S. patent application Ser. No. 10/075,778, filed on Feb. 14, 2002, now issued as U.S. Pat. No. 6,741,221, which claimed priority to U.S. Provisional Patent Applications Ser. No. 60/317,808, filed on Sep. 7, 2001, Ser. No. 60/269,414, filed on Feb. 16, 2001, and Ser. No. 60/268,822, filed on Feb. 15, 2001, all of which are incorporated by reference in their entirety.

### BACKGROUND OF THE INVENTION

(1) Field of the Invention

This invention relates to hardware fastening devices and, more particularly, to hardware fastening devices molded of conductive loaded resin-based materials comprising micron conductive powders, micron conductive fibers, or a combination thereof, substantially homogenized within a base resin when molded. This manufacturing process yields a conductive part or material usable within the EMF or electronic spectrum(s).

(2) Description of the Prior Art

Hardware fasteners are used in most every type of manufactured device. Screws, bolts, nuts, rivets, and the like, are used to hold together various pieces of product assemblies. Typically, hardware fasteners are formed either of metal or of a resin-based, or plastic, material. Metal fasteners typically require metal stamping, forging, or turning operations to shape the metal into the fastener form. Such operations require expensive tooling that is worn away during cutting or shaping of the metal. Plastic fasteners are typically easier to form since the shape can be molded while the material is in a softened state. Therefore, forming the part does not create the type of tool wear found in metal forming. Typically, metal fasteners provide higher thermal and electrical conductivity and strength than plastic fasteners. By comparison, plastic components typically provide lower weight and better resistance to corrosive environments. It is a primary object of the present invention to combine these features in a single hardware fastener device.

Several prior art inventions relate to plastic or composite hardware fastening devices. U.S. Pat. No. 5,209,888 to Shimada et al teaches a method to produce screw-like fastening elements from fiber-reinforced plastic (FRP). The FRP material comprises a thermoplastic and carbon fiber. The screw-like fasteners are formed using molding techniques. A pressure stick of steel may be added to strength the fasteners. U.S. Pat. No. 4,369,644 to Min-Chin et al teaches an apparatus for making metal screws. A planetary mechanism cuts screw threads. U.S. Pat. No. 4,561,277 to Taubert et al teaches a method for making metal screws. A first process forms a blank rod with a lobular cross section. The blank is then threaded by turning in a die.

### SUMMARY OF THE INVENTION

A principal object of the present invention is to provide an effective hardware fastener.

A further object of the present invention is to provide a method to form a hardware fastener.

A further object of the present invention is to provide an effective hardware fastener having excellent electrical conductivity.

A further object of the present invention is to provide an effective hardware fastener having excellent thermal conductivity.

A further object of the present invention is to provide an effective hardware fastener that is non-corrosive.

A further object of the present invention is to provide an effective hardware fastener that is low in weight.

A further object of the present invention is to provide an effective hardware fastener that is magnetic or magnetizable.

A yet further object of the present invention is to provide a hardware fastener molded of conductive loaded resin-based material where the electrical, thermal, or mechanical characteristics can be altered or the visual characteristics can be altered by forming a metal layer over the conductive loaded resin-based material.

In accordance with the objects of this invention, a conductive fastening device is achieved. The device comprises a shaft and an end header connected to a first end of the shaft. The shaft and the end header comprise a conductive loaded, resin-based material comprising conductive materials in a base resin host.

Also in accordance with the objects of this invention, a conductive fastening device is achieved. The device comprises a shaft and an end header connected to a first end of the shaft. The shaft and the end header comprise a conductive loaded, resin-based material comprising conductive materials in a base resin host. The percent by weight of the conductive materials is between about 20% and about 50% of the total weight of the conductive loaded resin-based material.

Also in accordance with the objects of this invention, a conductive fastening device is achieved. The device comprises a shaft and an end header connected to a first end of the shaft. The shaft and the end header comprise a conductive loaded, resin-based material comprising micron conductive fiber in a base resin host. The percent by weight of the conductive fiber is between about 20% and about 50% of the total weight of the conductive loaded resin-based material.

Also in accordance with the objects of this invention, a method to form a conductive fastening device is achieved. The method comprises providing a conductive loaded, resin-based material comprising conductive materials in a resin-based host. The conductive loaded, resin-based material is molded into a conductive fastening device. The device comprises a shaft and an end header connected to a first end of the shaft.

Also in accordance with the objects of this invention, a method to form a conductive fastening device is achieved. The method comprises providing a conductive loaded, resin-based material comprising conductive materials in a resin-based host. The percent by weight of the conductive materials is between 20% and 40% of the total weight of the conductive loaded resin-based material. The conductive loaded, resin-based material is molded into a conductive fastening device. The device comprises a shaft and an end header connected to a first end of the shaft.

Also in accordance with the objects of this invention, a method to form a conductive fastening device is achieved. The method comprises providing a conductive loaded, resin-based material comprising micron conductive fiber in a resin-based host. The percent by weight of said micron conductive fiber is between 20% and 50% of the total weight of the conductive loaded resin-based material. The conductive loaded, resin-based material is molded into a conductive fastening device. The device comprises a shaft and an end header connected to a first end of the shaft.

### BRIEF DESCRIPTION OF THE DRAWINGS

In the accompanying drawings forming a material part of this description, there is shown:

FIGS. 1a and 1b illustrate a first preferred embodiment of the present invention showing a hardware screw device formed of the conductive loaded resin-based material according to the present invention.

FIG. 2 illustrates a first preferred embodiment of a conductive loaded resin-based material wherein the conductive materials comprise a powder.

FIG. 3 illustrates a second preferred embodiment of a conductive loaded resin-based material wherein the conductive materials comprise micron conductive fibers.

FIG. 4 illustrates a third preferred embodiment of a conductive loaded resin-based material wherein the conductive materials comprise both conductive powder and micron conductive fibers.

FIGS. 5a and 5b illustrate a fourth preferred embodiment wherein conductive fabric-like materials are formed from the conductive loaded resin-based material.

FIGS. 6a and 6b illustrate, in simplified schematic form, an injection molding apparatus and an extrusion molding apparatus that may be used to mold hardware devices of a conductive loaded resin-based material.

FIGS. 7a and 7b illustrate a second preferred embodiment of the present invention showing a hardware nut device formed of the conductive loaded resin-based material according to the present invention.

FIGS. 8a and 8b illustrate a third preferred embodiment of the present invention showing a hardware bolt device formed of the conductive loaded resin-based material according to the present invention.

FIGS. 9a and 9b illustrate a fourth preferred embodiment of the present invention showing a hardware pop rivet device formed of the conductive loaded resin-based material according to the present invention.

FIG. 10 illustrates a fifth preferred embodiment of the present invention showing a hardware snap rivet device formed of the conductive loaded resin-based material according to the present invention.

FIG. 11 illustrates a sixth preferred embodiment of the present invention showing a hardware push-in snap rivet device formed of the conductive loaded resin-based material according to the present invention.

### DESCRIPTION OF THE PREFERRED EMBODIMENTS

This invention relates to hardware devices molded of conductive loaded resin-based materials comprising micron conductive powders, micron conductive fibers, or a combination thereof, substantially homogenized within a base resin when molded.

The conductive loaded resin-based materials of the invention are base resins loaded with conductive materials, which then makes any base resin a conductor rather than an insulator. The resins provide the structural integrity to the molded part. The micron conductive fibers, micron conductive powders, or a combination thereof, are substantially homogenized within the resin during the molding process, providing the electrical continuity.

The conductive loaded resin-based materials can be molded, extruded or the like to provide almost any desired shape or size. The molded conductive loaded resin-based materials can also be cut, stamped, or vacuumed formed from an injection molded or extruded sheet or bar stock, over-molded, laminated, milled or the like to provide the desired shape and size. The thermal or electrical conductivity characteristics of hardware devices fabricated using conductive loaded resin-based materials depend on the composition of the conductive loaded resin-based materials, of which the loading or doping parameters can be adjusted, to aid in achieving the desired structural, electrical or other physical characteristics of the material. The selected materials used to fabricate the hardware devices are substantially homogenized together using molding techniques and or methods such as injection molding, over-molding, insert molding, thermo-set, protrusion, extrusion or the like. Characteristics related to 2D, 3D, 4D, and 5D designs, molding and electrical characteristics, include the physical and electrical advantages that can be achieved during the molding process of the actual parts and the polymer physics associated within the conductive networks within the molded part(s) or formed material(s).

In the conductive loaded resin-based material, electrons travel from point to point when under stress, following the path of least resistance. Most resin-based materials are insulators and represent a high resistance to electron passage. The doping of the conductive loading into the resin-based material alters the inherent resistance of the polymers. At a threshold concentration of conductive loading, the resistance through the combined mass is lowered enough to allow electron movement. Speed of electron movement depends on conductive loading concentration, that is, the separation between the conductive loading particles. Increasing conductive loading content reduces interparticle separation distance, and, at a critical distance known as the percolation point, resistance decreases dramatically and electrons move rapidly.

Resistivity is a material property that depends on the atomic bonding and on the microstructure of the material. The atomic microstructure material properties within the conductive loaded resin-based material are altered when molded into a structure. A substantially homogenized conductive microstructure of delocalized valance electrons is created. This microstructure provides sufficient charge carriers within the molded matrix structure. As a result, a low density, low resistivity, lightweight, durable, resin based polymer microstructure material is achieved. This material exhibits conductivity comparable to that of highly conductive metals such as silver, copper or aluminum, while maintaining the superior structural characteristics found in many plastics and rubbers or other structural resin based materials.

The use of conductive loaded resin-based materials in the fabrication of hardware devices significantly lowers the cost of materials and the design and manufacturing processes used to hold ease of close tolerances, by forming these materials into desired shapes and sizes. The hardware devices can be manufactured into infinite shapes and sizes using conventional forming methods such as injection molding, over-molding, or extrusion or the like. The conductive loaded resin-based materials, when molded, typically but not exclusively produce a desirable usable range of resistivity from between about 5 and 25 ohms per square, but other resistivities can be achieved by varying the doping parameters and/or resin selection(s).

The conductive loaded resin-based materials comprise micron conductive powders, micron conductive fibers, or any combination thereof, which are substantially homogenized together within the base resin, during the molding process, yielding an easy to produce low cost, electrically conductive, close tolerance manufactured part or circuit. The resulting molded article comprises a three dimensional, continuous network of conductive loading and polymer matrix. The micron conductive powders can be of carbons, graphites, amines or the like, and/or of metal powders such as nickel, copper, silver, aluminum, or plated or the like. The use of carbons or other forms of powders such as graphite(s) etc. can create additional low level electron exchange and, when used in combination with micron conductive fibers, creates a micron filler element within the micron conductive network of fiber(s) producing further electrical conductivity as well as acting as a lubricant for the molding equipment. The micron conductive fibers may be metal fiber or metal plated fiber. Further, the metal plated fiber may be formed by metal plating onto a metal fiber or metal plating onto a non-metal fiber. Exemplary micron conductive fibers include nickel plated carbon fiber, stainless steel fiber, copper fiber, silver fiber, aluminum fiber, or the like, or combinations thereof. Metal plating for fiber include copper, nickel, cobalt, silver, gold, palladium, platinum, ruthenium, and rhodium, and alloys of thereof. Non-metal fiber cores include carbon, graphite, polyester, and other synthetic materials. Superconductor metals, such as titanium, nickel, niobium, and zirconium, and alloys of titanium, nickel, niobium, and zirconium may also be used as micron conductive fibers in the present invention. The structural material is a material such as any polymer resin. Structural material can be, here given as examples and not as an exhaustive list, polymer resins produced by GE PLASTICS, Pittsfield, Mass., a range of other plastics produced by GE PLASTICS, Pittsfield, Mass., a range of other plastics produced by other manufacturers, silicones produced by GE SILICONES, Waterford, N.Y., or other flexible resin-based rubber compounds produced by other manufacturers.

The resin-based structural material loaded with micron conductive powders, micron conductive fibers, or in combination thereof can be molded, using conventional molding methods such as injection molding or over-molding, or extrusion to create desired shapes and sizes. The molded conductive loaded resin-based materials can also be stamped, cut or milled as desired to form create the desired shape form factor(s) of the hardware devices. The doping composition and directionality associated with the micron conductors within the loaded base resins can affect the electrical and structural characteristics of the hardware devices and can be precisely controlled by mold designs, gating and or protrusion design(s) and or during the molding process itself. In addition, the resin base can be selected to obtain the desired thermal characteristics such as very high melting point or specific thermal conductivity.

A resin-based sandwich laminate could also be fabricated with random or continuous webbed micron stainless steel fibers or other conductive fibers, forming a cloth like material. The webbed conductive fiber can be laminated or the like to materials such as Teflon, Polyesters, or any resin-based flexible or solid material(s), which when discretely designed in fiber content(s), orientation(s) and shape(s), will produce a very highly conductive flexible cloth-like material. Such a cloth-like material could also be used in forming hardware devices that could be embedded in a person's clothing as well as other resin materials such as rubber(s) or plastic(s). When using conductive fibers as a webbed conductor as part of a laminate or cloth-like material, the fibers may have diameters of between about 3 and 12 microns, typically between about 8 and 12 microns or in the range of about 10 microns, with length(s) that can be seamless or overlapping.

The conductive loaded resin-based material of the present invention can be made resistant to corrosion and/or metal electrolysis by selecting micron conductive fiber and/or micron conductive powder and base resin that are resistant to corrosion and/or metal electrolysis. For example, if a corrosion/electrolysis resistant base resin is combined with stainless steel fiber and carbon fiber/powder, then a corrosion and/or metal electrolysis resistant conductive loaded resin-based material is achieved. Another additional and important feature of the present invention is that the conductive loaded resin-based material of the present invention may be made flame retardant. Selection of a flame-retardant (FR) base resin material allows the resulting product to exhibit flame retardant capability. This is especially important in hardware device applications as described herein.

The substantially homogeneous mixing of micron conductive fiber and/or micron conductive powder and base resin described in the present invention may also be described as doping. That is, the substantially homogeneous mixing converts the typically non-conductive base resin material into a conductive material. This process is analogous to the doping process whereby a semiconductor material, such as silicon, can be converted into a conductive material through the introduction of donor/acceptor ions as is well known in the art of semiconductor devices. Therefore, the present invention uses the term doping to mean converting a typically non-conductive base resin material into a conductive material through the substantially homogeneous mixing of micron conductive fiber and/or micron conductive powder into a base resin.

As an additional and important feature of the present invention, the molded conductor loaded resin-based material exhibits excellent thermal dissipation characteristics. Therefore, hardware devices manufactured from the molded conductor loaded resin-based material can provide added thermal dissipation capabilities to the application. For example, heat can be dissipated from electrical devices physically and/or electrically connected to hardware devices of the present invention.

As a significant advantage of the present invention, hardware devices constructed of the conductive loaded resin-based material can be easily interfaced to an electrical circuit or grounded. In one embodiment, a wire can be attached to any conductive loaded resin-based device via a conductive loaded resin-based material screw that is fastened to the device. For example, a simple conductive loaded resin-based self tapping screw, when fastened to the material, can achieve excellent electrical connectivity via the conductive matrix of the conductive loaded resin-based material. To facilitate this approach a boss may be molded into the conductive loaded resin-based material to accommodate such a screw. In another embodiment, the conductive loaded resin-based material is partly or completely plated with a metal layer. The metal layer forms excellent electrical conductivity with the conductive matrix. A connection of this metal layer to another circuit or to ground is then made. For example, if the metal layer is solderable, then a soldered connection may be made between the hardware device and a grounding wire.

A typical metal deposition process for forming a metal layer onto the conductive loaded resin-based material is vacuum metallization. Vacuum metallization is the process where a metal layer, such as aluminum, is deposited on the conductive loaded resin-based material inside a vacuum chamber. In a metallic painting process, metal particles, such as silver, copper, or nickel, or the like, are dispersed in an acrylic, vinyl, epoxy, or urethane binder. Most resin-based materials accept and hold paint well, and automatic spraying systems apply coating with consistency. In addition, the excellent conductivity of the conductive loaded resin-based material of the present invention facilitates the use of extremely efficient, electrostatic painting techniques.

The conductive loaded resin-based material can be contacted in any of several ways. In one embodiment, a pin is embedded into the conductive loaded resin-based material by insert molding, ultrasonic welding, pressing, or other means. A connection with a metal wire can easily be made to this pin and results in excellent contact to the conductive loaded resin-based material. In another embodiment, a hole is formed in to the conductive loaded resin-based material either during the molding process or by a subsequent process step such as drilling, punching, or the like. A pin is then placed into the hole and is then ultrasonically welded to form a permanent mechanical and electrical contact. In yet another embodiment, a pin or a wire is soldered to the conductive loaded resin-based material. In this case, a hole is formed in the conductive loaded resin-based material either during the molding operation or by drilling, stamping, punching, or the like. A solderable layer is then formed in the hole. The solderable layer is preferably formed by metal plating. A conductor is placed into the hole and then mechanically and electrically bonded by point, wave, or reflow soldering.

Another method to provide connectivity to the conductive loaded resin-based material is through the application of a solderable ink film to the surface. One exemplary solderable ink is a combination of copper and solder particles in an epoxy resin binder. The resulting mixture is an active, screen-printable and dispensable material. During curing, the solder reflows to coat and to connect the copper particles and to thereby form a cured surface that is directly solderable without the need for additional plating or other processing steps. Any solderable material may then be mechanically and/or electrically attached, via soldering, to the conductive loaded resin-based material at the location of the applied solderable ink. Many other types of solderable inks can be used to provide this solderable surface onto the conductive loaded resin-based material of the present invention. Another exemplary embodiment of a solderable ink is a mixture of one or more metal powder systems with a reactive organic medium. This type of ink material is converted to solderable pure metal during a low temperature cure without any organic binders or alloying elements.

A ferromagnetic conductive loaded resin-based material may be formed of the present invention to create a magnetic or magnetizable form of the material. Ferromagnetic micron conductive fibers and/or ferromagnetic conductive powders are mixed with the base resin. Ferrite materials and/or rare earth magnetic materials are added as a conductive loading to the base resin. With the substantially homogeneous mixing of the ferromagnetic micron conductive fibers and/or micron conductive powders, the ferromagnetic conductive loaded resin-based material is able to produce an excellent low cost, low weight magnetize-able item. The magnets and magnetic devices of the present invention can be magnetized during or after the molding process. The magnetic strength of the magnets and magnetic devices can be varied by adjusting the amount of ferromagnetic micron conductive fibers and/or ferromagnetic micron conductive powders that are incorporated with the base resin. By increasing the amount of the ferromagnetic doping, the strength of the magnet or magnetic devices is increased. The substantially homogenous mixing of the conductive fiber network allows for a substantial amount of fiber to be added to the base resin without causing the structural integrity of the item to decline. The ferromagnetic conductive loaded resin-based magnets display the excellent physical properties of the base resin, including flexibility, moldability, strength, and resistance to environmental corrosion, along with excellent magnetic ability. In addition, the unique ferromagnetic conductive loaded resin-based material facilitates formation of items that exhibit excellent thermal and electrical conductivity as well as magnetism.

A high aspect ratio magnet is easily achieved through the use of ferromagnetic conductive micron fiber or through the combination of ferromagnetic micron powder with conductive micron fiber. The use of micron conductive fiber allows for molding articles with a high aspect ratio of conductive fiber to cross sectional area. If a ferromagnetic micron fiber is used, then this high aspect ratio translates into a high quality magnetic article. Alternatively, if a ferromagnetic micron powder is combined with micron conductive fiber, then the magnetic effect of the powder is effectively spread throughout the molded article via the network of conductive fiber such that an effective high aspect ratio molded magnetic article is achieved. The ferromagnetic conductive loaded resin-based material may be magnetized, after molding, by exposing the molded article to a strong magnetic field. Alternatively, a strong magnetic field may be used to magnetize the ferromagnetic conductive loaded resin-based material during the molding process.

Exemplary ferromagnetic conductive fiber materials include ferrite, or ceramic, materials as nickel zinc, manganese zinc, and combinations of iron, boron, and strontium, and the like. In addition, rare earth elements, such as neodymium and samarium, typified by neodymium-iron-boron, samarium-cobalt, and the like, are useful ferromagnetic conductive fiber materials. Exemplary non-ferromagnetic conductor fibers include stainless steel, nickel, copper, silver, aluminum, or other suitable metals or conductive fibers, alloys, plated materials, or combinations thereof. Superconductor metals, such as titanium, nickel, niobium, and zirconium, and alloys of titanium, nickel, niobium, and zirconium may also be used as micron conductive fibers in the present invention. Exemplary ferromagnetic micron powder leached onto the conductive fibers include ferrite, or ceramic, materials as nickel zinc, manganese zinc, and combinations of iron, boron, and strontium, and the like. In addition, rare earth elements, such as neodymium and samarium, typified by neodymium-iron-boron, samarium-cobalt, and the like, are useful ferromagnetic conductive powder materials.

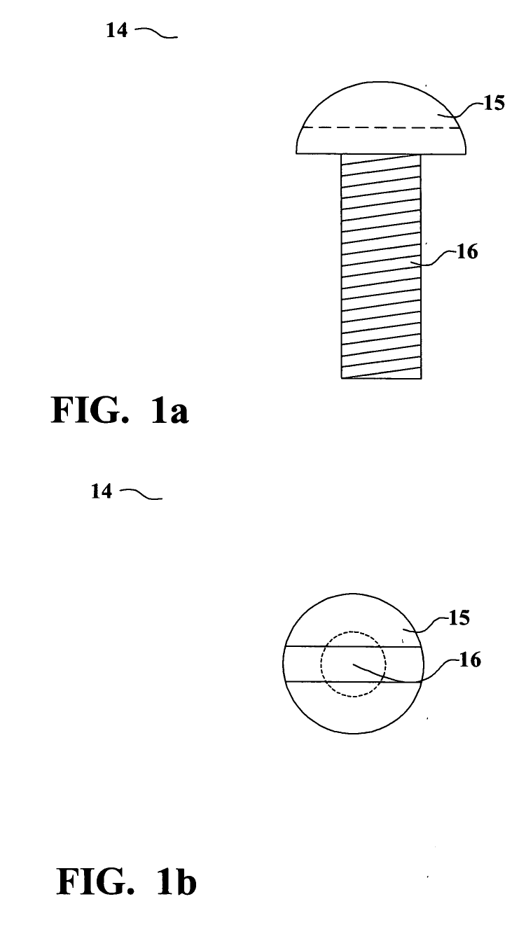

Referring now to FIGS. 1a and 1b, a first preferred embodiment of the present invention is illustrated. A hardware fastener device formed of the conductive loaded resin-based material is shown. Several important features of the present invention are shown and discussed below. The first preferred embodiment 10 of the present invention shows a very low cost screw 14 device formed of the conductive loaded resin-based material. The novel screw device 14 combines the material advantages of a plastic screw, such as non-corrosiveness, low weight, ease of manufacture, with the material advantages of a metal screw, such as electrical and thermal conductivity. FIG. 1a shows an exemplary side view, while FIG. 1b shows a top view. The screw header 15 and/or the shaft 16 comprises the conductive loaded resin-based material. In the preferred case, both header 15 and shaft 16 comprise conductive loaded resin-based material.

The screw device 14 comprises a screw head 15 and a screw shaft 16. In an application, the shaft 16 is inserted through a pre-formed hole in the item to which the screw 14 is to be attached or for which the screw is used for an attachment purpose. In the generic sense, the hardware fasteners of the present invention each comprise a shaft 16 capable of insertion into a hole in a material and an end header 15 capable of exerting a holding, or keeping, force when the fastener 14 is in place. In the case of this particular embodiment, the fastener 14 is further held into place by the action of threading on the shaft 16. In one embodiment, this threading holds directly against the material through which the screw shaft 16 is inserted as in the case of a self-tapping screw. In another embodiment, this threading holds to a second end header device, such as a nut.

In one embodiment, the screw device 14 is formed by injection molding. The screw head and shaft, including threading, is easily formed in a single molding step. In another embodiment, the screw device 14 is formed by extrusion. Additional machining steps, such as turning or grinding, are performed in some embodiments to form fine detail or ultra-precise features. A non-corrosive screw device 14 is formed by selecting a non-corrosive conductive loading material. In one embodiment, non-corrosive stainless steel fiber is selected as the conductive loading material. In another embodiment, a metal layer is formed onto the fastener device 14, after molding. In yet another embodiment, a ferromagnetic material is used for all or part of the conductive loading such that a magnetic or magnetizable hardware device is formed.

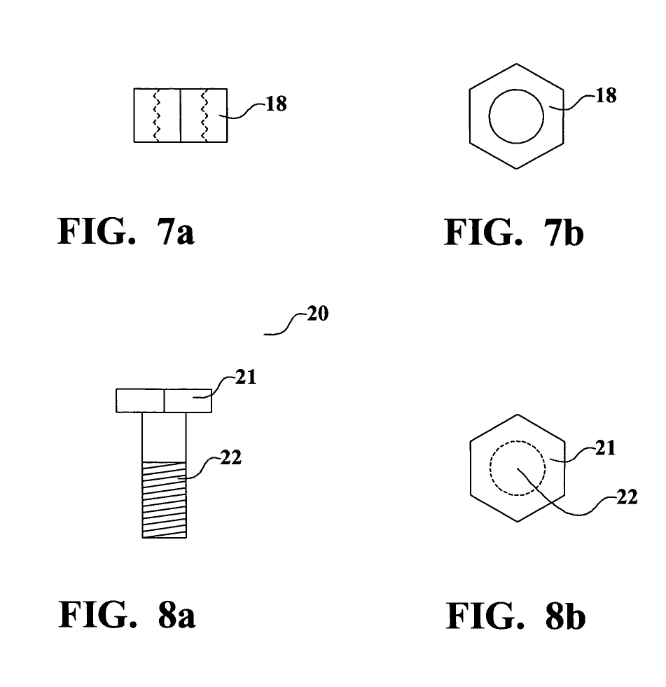

Referring now to FIGS. 7a and 7b, a second preferred embodiment of the present invention is illustrated. A hardware nut device 18 formed of the conductive loaded resin-based material is shown. The second preferred embodiment of the present invention shows a very low cost nut 18 device formed of the conductive loaded resin-based material. The novel nut device 18 combines the material advantages of a plastic nut, such as non-corrosiveness, low weight, and ease of manufacture, with the material advantages of a metal nut, such as electrical and thermal conductivity. FIG. 7a shows an exemplary side view, while FIG. 7b shows a top view.

The novel nut device 18 provides threading capable of mating to the threading of the screw device 14 of the first embodiment. In this application, the nut device 18 provides a second end header such that the combined screw 14 and nut 18 is capable of fastening. In one embodiment, the nut device 18 is formed by injection molding. The nut body, including threading, is easily formed in a single molding step. In another embodiment, the nut device 18 is formed by extrusion. Additional machining steps, such as turning or grinding, are performed in some embodiments to form fine detail or ultra-precise features. A non-corrosive nut device 18 is formed by selecting a non-corrosive conductive loading material. In one embodiment, non-corrosive stainless steel fiber is selected as the conductive loading material.

Referring now to FIGS. 8a and 8b, a third preferred embodiment of the present invention is illustrated. A hardware bolt device 20 formed of the conductive loaded resin-based material is shown. The second preferred embodiment of the present invention shows a very low cost bolt 20 device formed of the conductive loaded resin-based material. The novel bolt device 20 combines the material advantages of a plastic bolt, such as non-corrosiveness, low weight, and ease of manufacture, with the material advantages of a metal bolt, such as electrical and thermal conductivity. FIG. 8a shows an exemplary side view, while FIG. 8b shows a top view.

In one embodiment, the bolt device 20 is formed by injection molding. The bolt body comprises a shaft 22 and an end header 21 either of which comprises the conductive loaded resin-based material. In the preferred embodiment, both the shaft 22 and the end header 21 comprise conductive loaded resin-based material. The bolt 20 is easily formed in a single molding step. In another embodiment, the bolt device 20 is formed by extrusion. Additional machining steps, such as turning or grinding, are performed in some embodiments to form fine detail or ultra-precise features. A non-corrosive bolt device 20 is formed by selecting a non-corrosive conductive loading material. In one embodiment, non-corrosive stainless steel fiber is selected as the conductive loading material.

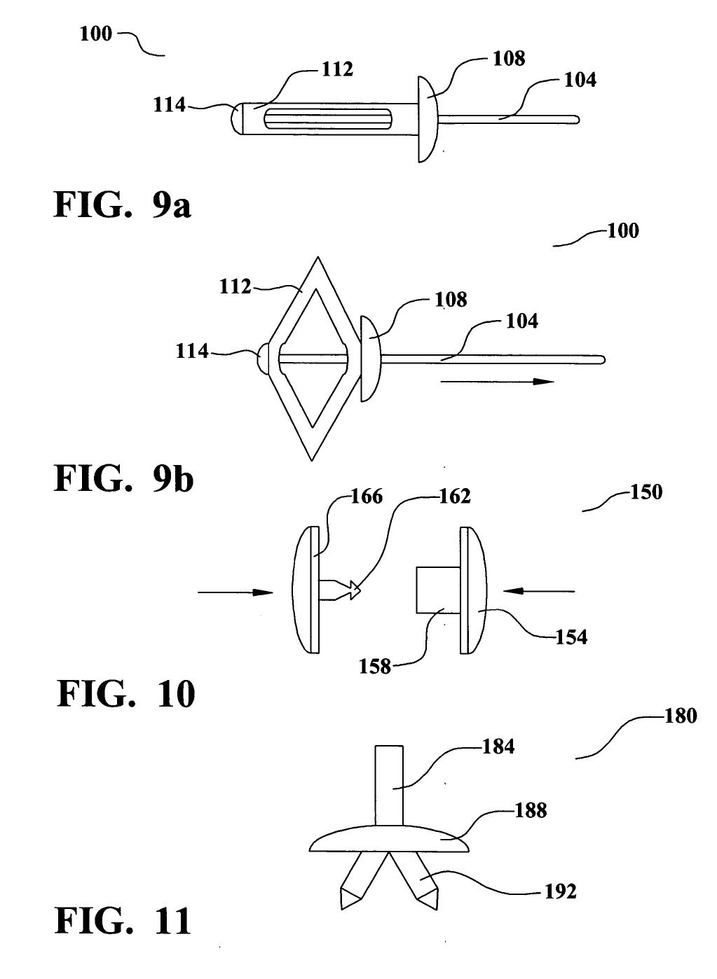

Referring now to FIGS. 9a and 9b, a fourth preferred embodiment of the present invention is illustrated. A pop rivet device 100 is shown. The pop rivet device 100 comprises a shaft 104, or pin, with an attached first end header 114 and a second end header 108 attached to an expansion body 112. The pop rivet device 100 is useful for coupling together panels or other sheeting, not shown. A hole is first drilled through the panels where the coupling is desired. The shaft 104 of the rivet 100 is inserted into a riveting gun, not shown, while the expansion body 112 and first end header 114 are inserted through a pre-formed hole in the panels. The riveting gun then pulls the rivet pin 104 such that the first end header 114 is pulled through the body 112. The first end header 114 is pulled towards the second end header 108 and causes the body 112 to expand.

In the present invention, the pop rivet device 100 comprises conductive loaded resin-based material as described herein. Any, or all, of the pop rivet components comprise the conductive loaded resin-based material of the present invention. A very low cost pop rivet device 100 is achieved. The novel pop rivet device 100 combines the material advantages of a plastic pop rivet, such as non-corrosiveness, low weight, ease of manufacture, with the material advantages of a metal pop rivet, such as electrical and thermal conductivity. FIGS. 9a and 9b show exemplary views of the pop rivet device 100 before and after the rivet pin is pulled, or ‘popped’.

In one embodiment, the pop rivet device 100 is formed by injection molding. The shaft 104 with the first end header 114 is molded as a first structure, while the body 112 and second end header 108 are molded as a second structure. The shaft 104 is then inserted into the body 112. In another embodiment, the shaft 104 and body 112 are formed by extrusion processes. A non-corrosive pop rivet device 100 is formed by selecting a non-corrosive conductive loading material. In one embodiment, non-corrosive stainless steel fiber is selected as the conductive loading material.

Referring now to FIG. 10, a fifth preferred embodiment of the present invention is illustrated. A snap rivet device 150 is shown. The snap rivet device 150 comprises a male side having a first shaft 162 and a first end header 166 and a female side having a second shaft 158 and a second end header 154. Either, and preferably both, sides of the snap rivet 150 comprise conductive loaded resin-based material. The snap rivet device 150 is useful for coupling together panels or other sheeting, as in the previous embodiment. A hole is first drilled through the panels where the coupling is desired. The female shaft 158 is inserted through the hole in the panels. The male shaft 162 is then pushed into the female into to complete the mating and to lock the panels together.

In the present invention, the snap rivet device 150 comprises conductive loaded resin-based material as described herein. A very low cost snap rivet device 150 is achieved. The novel snap rivet device 150 combines the material advantages of a plastic snap rivet, such as non-corrosiveness, low weight, ease of manufacture, with the material advantages of a metal snap rivet, such as electrical and thermal conductivity. In one embodiment, the snap rivet device 150 is formed by injection molding. The male end 166 and 162 and the female end 154 and 158 are molded as separate structures. In another embodiment, the male end 166 and 162 and the female end 154 and 158 are formed by extrusion processes. A non-corrosive snap rivet device 150 is formed by selecting a non-corrosive conductive loading material. In one embodiment, non-corrosive stainless steel fiber is selected as the conductive loading material.

Referring now to FIG. 11, a sixth preferred embodiment of the present invention is illustrated. A push-in snap rivet device 180 is shown. The push-in snap rivet device 180 comprises a handle 184, an end header 188, and tapered prongs 192 that snap into a hole to secure the rivet. Any or all of the components 184, 188, and 192 comprise conductive loaded resin-based material. The push-in snap rivet device 150 is useful for coupling together panels or other sheeting, as in the previous embodiment. A hole is first drilled through the panels where the coupling is desired. The tapered prongs 192 are inserted through the hole in the panels and then pushed toward the panel to lock the device 180 into place.

In the present invention, the push-in snap rivet device 180 comprises conductive loaded resin-based material as described herein. A very low cost push-in snap rivet device 180 is achieved. The novel push-in snap rivet device 180 combines the material advantages of a plastic snap rivet, such as non-corrosiveness, low weight, and ease of manufacture, with the material advantages of a metal snap rivet, such as electrical and thermal conductivity. In one embodiment, the push-in snap rivet device 180 is formed by injection molding. In another embodiment, the push-in snap rivet device 180 is formed by an extrusion process. A non-corrosive push-in snap rivet device 180 is formed by selecting a non-corrosive conductive loading material. In one embodiment, non-corrosive stainless steel fiber is selected as the conductive loading material.

Many other hardware devices and/or fastening devices may be formed of the conductive loaded resin-based material according to the present invention. For example, panel fasteners, plastic clips, grommets, ratchet rivets, removable rivets, support and wiring clamps, circuit board spacers, and the like, may be formed of the conductive loaded resin-based material to provide fasteners and hardware devices with excellent electrical and thermal conductivity as well as resistance to corrosion.

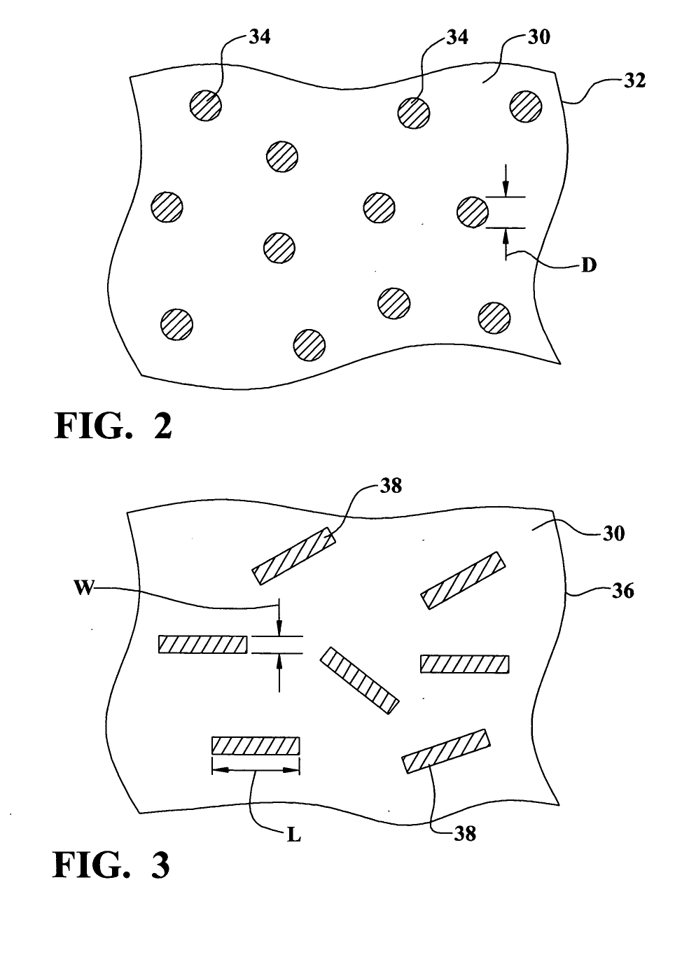

The conductive loaded resin-based material of the present invention typically comprises a micron powder(s) of conductor particles and/or in combination of micron fiber(s) substantially homogenized within a base resin host. FIG. 2 shows cross section view of an example of conductor loaded resin-based material 32 having powder of conductor particles 34 in a base resin host 30. In this example the diameter D of the conductor particles 34 in the powder is between about 3 and 12 microns.

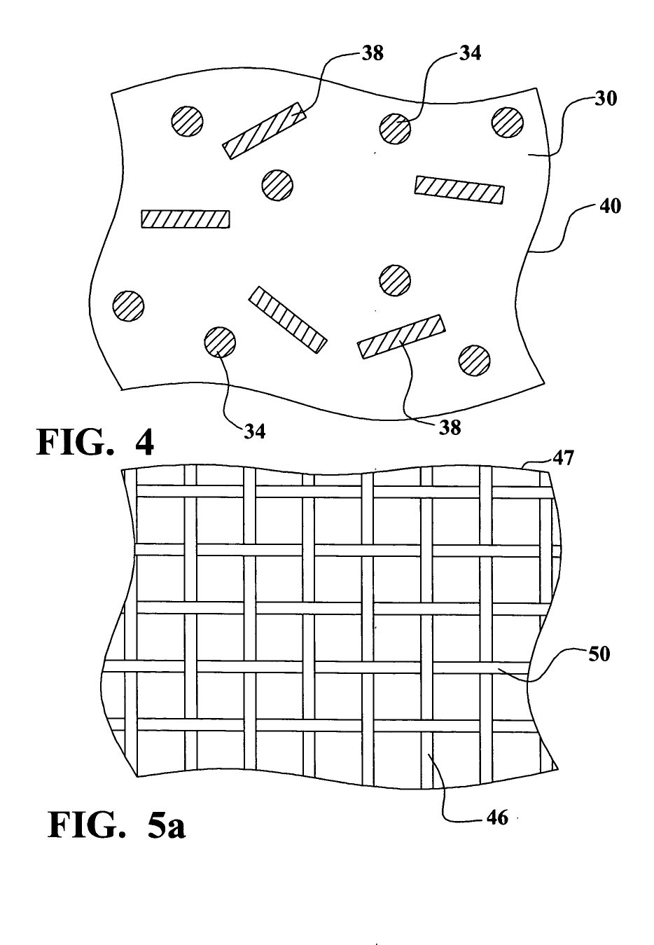

FIG. 3 shows a cross section view of an example of conductor loaded resin-based material 36 having conductor fibers 38 in a base resin host 30. The conductor fibers 38 have a diameter of between about 3 and 12 microns, typically in the range of 10 microns or between about 8 and 12 microns, and a length of between about 2 and 14 millimeters. The conductors used for these conductor particles 34 or conductor fibers 38 can be stainless steel, nickel, copper, silver, aluminum, or other suitable metals or conductive fibers, or combinations thereof. Superconductor metals, such as titanium, nickel, niobium, and zirconium, and alloys of titanium, nickel, niobium, and zirconium may also be used as micron conductive fibers in the present invention. These conductor particles and or fibers are substantially homogenized within a base resin. As previously mentioned, the conductive loaded resin-based materials have a sheet resistance between about 5 and 25 ohms per square, though other values can be achieved by varying the doping parameters and/or resin selection. To realize this sheet resistance the weight of the conductor material comprises between about 20% and about 50% of the total weight of the conductive loaded resin-based material. More preferably, the weight of the conductive material comprises between about 20% and about 40% of the total weight of the conductive loaded resin-based material. More preferably yet, the weight of the conductive material comprises between about 25% and about 35% of the total weight of the conductive loaded resin-based material. Still more preferably yet, the weight of the conductive material comprises about 30% of the total weight of the conductive loaded resin-based material. Stainless Steel Fiber of 6-12 micron in diameter and lengths of 4-6 mm and comprising, by weight, about 30% of the total weight of the conductive loaded resin-based material will produce a very highly conductive parameter, efficient within any EMF spectrum. Referring now to FIG. 4, another preferred embodiment of the present invention is illustrated where the conductive materials comprise a combination of both conductive powders 34 and micron conductive fibers 38 substantially homogenized together within the resin base 30 during a molding process.

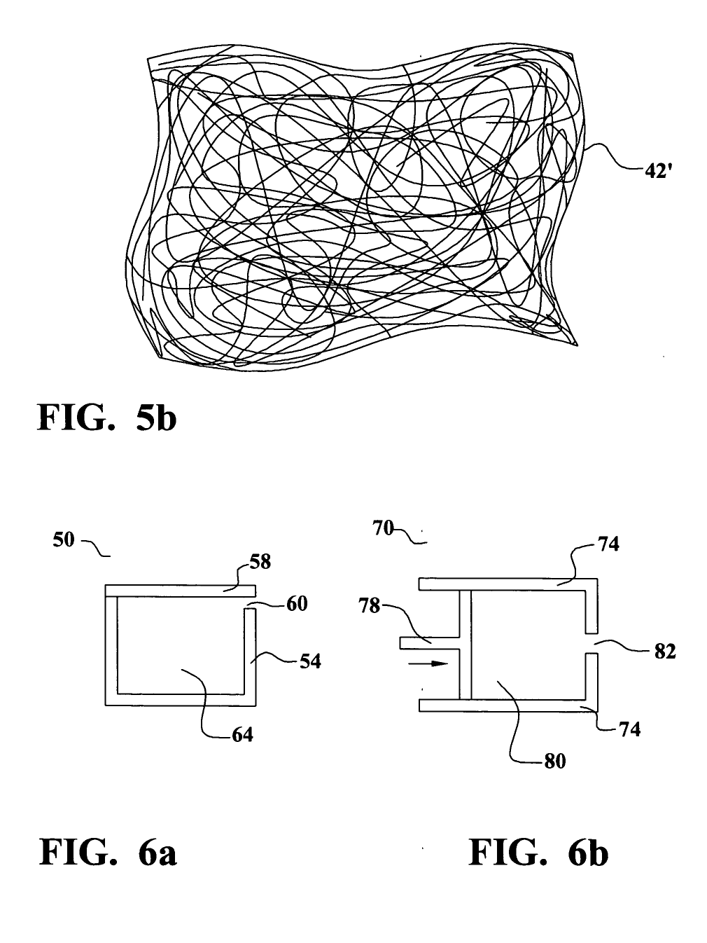

Referring now to FIGS. 5a and 5b, a preferred composition of the conductive loaded, resin-based material is illustrated. The conductive loaded resin-based material can be formed into fibers or textiles that are then woven or webbed into a conductive fabric. The conductive loaded resin-based material is formed in strands that can be woven as shown. FIG. 5a shows a conductive fabric 42 where the fibers are woven together in a two-dimensional weave 46 and 50 of fibers or textiles. FIG. 5b shows a conductive fabric 42′ where the fibers are formed in a webbed arrangement. In the webbed arrangement, one or more continuous strands of the conductive fiber are nested in a random fashion. The resulting conductive fabrics or textiles 42, see FIG. 5a, and 42′, see FIG. 5b, can be made very thin, thick, rigid, flexible or in solid form(s).

Similarly, a conductive, but cloth-like, material can be formed using woven or webbed micron stainless steel fibers, or other micron conductive fibers. These woven or webbed conductive cloths could also be sandwich laminated to one or more layers of materials such as Polyester(s), Teflon(s), Kevlar(s) or any other desired resin-based material(s). This conductive fabric may then be cut into desired shapes and sizes.

Hardware devices formed from conductive loaded resin-based materials can be formed or molded in a number of different ways including injection molding, extrusion or chemically induced molding or forming. FIG. 6a shows a simplified schematic diagram of an injection mold showing a lower portion 54 and upper portion 58 of the mold 50. Conductive loaded blended resin-based material is injected into the mold cavity 64 through an injection opening 60 and then the substantially homogenized conductive material cures by thermal reaction. The upper portion 58 and lower portion 54 of the mold are then separated or parted and the hardware devices are removed.

FIG. 6b shows a simplified schematic diagram of an extruder 70 for forming hardware devices using extrusion. Conductive loaded resin-based material(s) is placed in the hopper 80 of the extrusion unit 74. A piston, screw, press or other means 78 is then used to force the thermally molten or a chemically induced curing conductive loaded resin-based material through an extrusion opening 82 which shapes the thermally molten curing or chemically induced cured conductive loaded resin-based material to the desired shape. The conductive loaded resin-based material is then fully cured by chemical reaction or thermal reaction to a hardened or pliable state and is ready for use. Thermoplastic or thermosetting resin-based materials and associated processes may be used in molding the conductive loaded resin-based articles of the present invention.

The advantages of the present invention may now be summarized. An effective hardware fastener is achieved. A method to form a hardware fastener is also achieved. The hardware fastener has excellent electrical conductivity and thermal conductivity. The hardware fastener is non-corrosive. The hardware device is low in weight. The electrical, thermal, or mechanical characteristics of the hardware device can be altered or the visual characteristics can be altered by forming a metal layer over the conductive loaded resin-based material. The hardware device is made magnetic by the inclusion of ferromagnetic material into the conductive loading.

As shown in the preferred embodiments, the novel methods and devices of the present invention provide an effective and manufacturable alternative to the prior art.

While the invention has been particularly shown and described with reference to the preferred embodiments thereof, it will be understood by those skilled in the art that various changes in form and details may be made without departing from the spirit and scope of the invention.

1. A conductive fastening device comprising:
a shaft; and
an end header connected to a first end of said shaft wherein said shaft and said end header comprise a conductive loaded, resin-based material comprising conductive materials in a base resin host.

2. The device according to claim 1 wherein the percent by weight of said conductive materials is between about 20% and about 50% of the total weight of said conductive loaded resin-based material.

3. The device according to claim 1 wherein said conductive materials comprise micron conductive fiber.

4. The device according to claim 2 wherein said conductive materials further comprise conductive powder.

5. The device according to claim 1 wherein said conductive materials are metal.

6. The device according to claim 1 wherein said conductive materials are non-conductive materials with metal plating.

7. The device according to claim 1 wherein said shaft is threaded.

8. The device according to claim 1 further comprising a second end header comprising said conductive loaded resin-based material wherein said second end header mates to said shaft.

9. The device according to claim 8 wherein said second end header is threaded.

10. The device according to claim 1 further comprising a metal layer overlying said conductive loaded resin-based material.

11. A conductive fastening device comprising:
a shaft; and
an end header connected to a first end of said shaft wherein said shaft and said end header comprise a conductive loaded, resin-based material comprising conductive materials in a base resin host wherein the percent by weight of said conductive materials is between 20% and 50% of the total weight of said conductive loaded resin-based material.

12. The device according to claim 11 wherein said conductive materials are nickel plated carbon micron fiber, stainless steel micron fiber, copper micron fiber, silver micron fiber or combinations thereof.

13. The device according to claim 11 wherein said conductive materials comprise micron conductive fiber and conductive powder.

14. The device according to claim 13 wherein said conductive powder is nickel, copper, or silver.

15. The device according to claim 13 wherein said conductive powder is a non-conductive material with a metal plating of nickel, copper, silver, or alloys thereof.

16. The device according to claim 11 wherein said shaft is threaded.

17. The device according to claim 11 further comprising a second end header comprising said conductive loaded resin-based material wherein said second end header mates to said shaft.

18. The device according to claim 11 wherein said conductive loaded resin-based material further comprises a ferromagnetic material.

19. The device according to claim 11 further comprising a metal layer overlying said conductive loaded resin-based material.

20. A conductive fastening device comprising:
a shaft; and
an end header connected to a first end of said shaft wherein said shaft and said end header comprise a conductive loaded, resin-based material comprising micron conductive fiber in a base resin host wherein the percent by weight of said conductive fiber is between 20% and 50% of the total weight of said conductive loaded resin-based material.

21. The device according to claim 20 wherein said micron conductive fiber is stainless steel.

22. The device according to claim 21 further comprising conductive powder.

23. The device according to claim 21 wherein said micron conductive fiber has a diameter of between about 3 μm and about 12 μm and a length of between about 2 mm and about 14 mm.

24. The device according to claim 21 wherein said shaft is threaded.

25. The device according to claim 21 further comprising a second end header comprising said conductive loaded resin-based material wherein said second end header mates to said shaft.
